(19) United States
(12) Patent Application Publication
(10) Pub. No.: US 2010/0186300 A1
(43) Pub. Date: Jul. 29, 2010

(54) EZ2 seal door

(76) Inventors: Keith Trageser, Panama City, FL (US); Heather Trageser, Panama City, FL (US)

Correspondence Address: Keith or Heather Trageser, 1219 Transmitter Road, Panama City, FL, 32401, US

(21) Appl. No.: 12/321,998

(22) Filed: Jan. 28, 2009

(51) Int. Cl. E06B 7/16; A44B 19/26; E06B 3/00

(52) U.S. Cl. 49/475.1; 24/385; 49/506

(57) ABSTRACT

EZ2 Seal Door is a device that secures to a doorway or other opening to prevent dust or other debris from circulating from one room to another during a construction or renovation project. A kelder welt is sewn into the outer edges of a canvas door. The welt is threaded through an aluminum or plastic track and this track is then mounted to the opening of the door providing a tight seal. The canvas door has a dual double pull zipper located in the center of the door that provides access to and from a sealed area. A small window is sewn into the canvas door to allow easy viewing into the sealed area.

### CROSS REFERENCE TO RELATED APPLICATIONS

This United States Non-Provisional Patent Application does not claim priority to any United States Provisional Patent Application or any foreign patent application.

### FIELD OF THE DISCLOSURE

The disclosures made herein relate generally to the construction and home renovation industries. The invention discussed herein is in the general classification of doorway covers.

### BACKGROUND

Many individuals have experienced the hassles that accompany home renovation and construction projects. These projects are often both expensive and time consuming. More elaborate projects may force a family or business from a home or office for an extended period of time. Debris and dust are two of the most common nuisances and dangers encountered during home improvement and construction projects. On some occasions, dangerous materials that create airborne debris must also be removed or disturbed to complete the project.

When only certain areas or portions of a home or office are being renovated, it is usually desirable to seal the areas that are being renovated from the other undisturbed areas.

Plastic placed and secured in a doorway or window is one common method used to cover an opening to an area under renovation. A plastic device placed in a window or doorway is often used to separate an area under renovation from an area that is not being renovated. This is particularly important when the renovation will necessarily create drywall dust, sawdust or other airborne debris. It is even more important to create this barrier when a hazardous material is being removed or disturbed.

Unfortunately, a plastic barrier taped or nailed into a doorframe is often ineffective and inconvenient to use. The plastic barrier does not form an airtight seal because it is difficult to secure it to a doorframe. It also does not permit convenient ingress and egress from the area undergoing the renovation and needs to be removed repeatedly during a renovation project to allow individuals and materials to enter and leave the renovated area. Moreover, typical plastic barriers are not environmentally friendly because they are usually discarded after a single use.

Hence, there is a need in the art for a convenient to use, inexpensive, durable, safe and effective device for covering a doorway and method for securing a cover to a doorway to contain dust and other hazardous debris.

### SUMMARY OF THE DISCLOSURE

EZ2 Seal Door is a device that secures to a doorway or other opening to prevent dust or other debris from circulating from one room to another during a construction or renovation project.

The preferred embodiment of the invention involves a canvas door that can be custom fit to any size having kelder welt sewn into the outer edges of the canvas. The welt is threaded through an aluminum or plastic track and this track is then mounted to a door frame providing a tight seal. The canvas door has a dual double pull zipper located in the center of the door that provides access to and from a sealed area. The zipper is flapped to prevent dust from entering other areas that may not be under renovation. A small clear window is sewn into the canvas door to allow easy viewing into the sealed area.

The principal object of this invention is to provide a device for preventing dust or other debris from circulating from one room to another during a construction or renovation project.

Another object of this invention is to provide a device that is easily installed for preventing dust or other debris from circulating from one room to another during a construction or renovation project.

Another object of this invention is to provide an affordable device for preventing dust or other debris from circulating from one room to another during a construction or renovation project.

Another object of this invention is to provide a safe device for preventing dust or other debris from circulating from one room to another during a construction or renovation project.

Another object of this invention is to provide a durable device for preventing dust or other debris from circulating from one room to another during a construction or renovation project.

Another object of this invention is to provide a device that creates an approximately airtight seal to prevent dust or other debris from circulating from one room to another during a construction or renovation project.

Another object of this invention is to provide a device for preventing dust or other debris from circulating from one room to another during a construction or renovation project while still permitting convenient access to and from the area.

Another object of this invention is to provide a reusable device for preventing dust or other debris from circulating from one room to another during a construction or renovation project.

Another object of this invention is to provide a method for installing a device for preventing dust or other debris from circulating from one room to another during a renovation project while still permitting convenient access to and from the room under renovation.

Another object of this invention is to provide an affordable method for installing a device that prevents dust or other debris from circulating from one room to another during a construction or renovation project while still permitting convenient access to and from the room under renovation.

Another object of this invention is to provide a method for installing a reusable device that prevents dust or other debris from circulating from one room to another during a construction or renovation project.

### BRIEF DESCRIPTION OF THE DRAWINGS

FIG. 1 depicts a front view of the preferred embodiment of the present invention.

FIG. 2 depicts a rear view of the preferred embodiment of the present invention.

### DETAILED DESCRIPTION OF THE DRAWINGS

The preferred embodiment of EZ2 Seal Door is comprised of at least some of the following: a canvas door, kelder welt sewn into the outer edges of the canvas door, an aluminum track that the kelder welt is threaded through, a dual double pull zipper on a zipper track located in the center of the canvas door, a flap covering the zipper track, and a small clear plastic window in the canvas door to permit viewing.

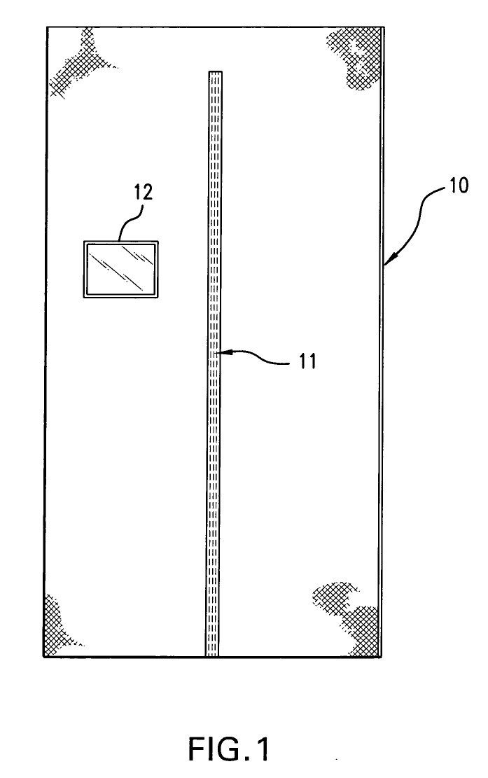

FIG. 1 depicts a front view of the preferred embodiment of the present invention. A canvas door 10 is designed to fit into opening such as a doorway or window. The canvas door 10 is approximately rectangular and made of twenty-two ounce weblon in this preferred embodiment.

A kelder welt (not pictured) is sewn into the outer edges of the canvas door. The welt can be threaded through an aluminum track (not pictured) and this track can then be mounted to a door frame to provide a tight seal. The track is typically attached to the door frame via screws through openings in the track or through the use of adhesive to secure the track in place.

The canvas door 10 has a dual double pull zipper located on a zipper track in the center of the door. The zipper is designed to provide access through the canvas door 10 to and from a sealed area. A zipper flap 11 covers the zipper track to prevent dust from entering other areas that may not be under renovation. The zipper flap 11 extends from approximately three-quarters of the way to the top of the canvas door 10 to the bottom of the canvas door 10 in this preferred embodiment. The dual double pull zipper of this preferred embodiment allows the slide to be located at various heights for security reasons.

A window 12 is sewn into the canvas door 10 to allow easy viewing into the sealed off area. The window 12 is made of clear plastic in this preferred embodiment and is located about two-thirds of the way to the top of the canvas door 10 and on one side of the zipper flap 11. The window 12 is a square that is eight inches by eight inches in this preferred embodiment though other shapes and sizes are also obviously possible.

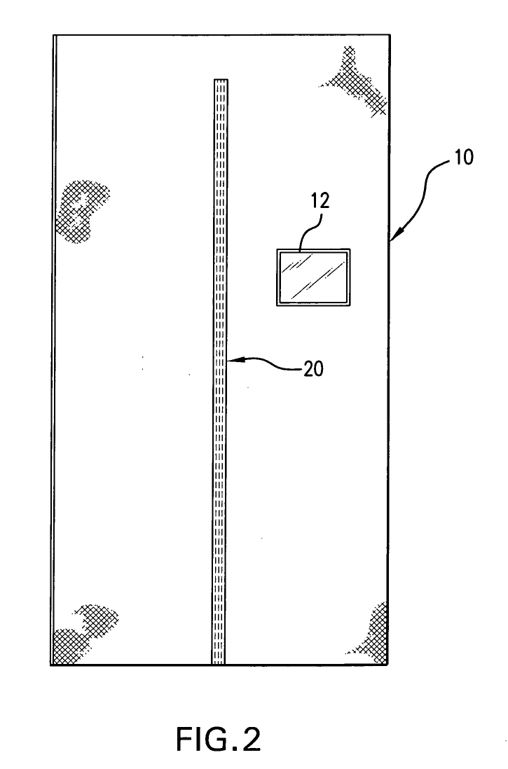

FIG. 2 depicts a rear view of the preferred embodiment of the present invention. A zipper flap 20 is shown in the center of the canvas door 10. The zipper flap 20 extends from approximately three-quarters of the way to the top of the canvas door 10 to the bottom of the canvas door 10 in this preferred embodiment.

The window 12 sewn into the canvas door 10 allows easy viewing into the sealed off area and from the sealed off area. The window 12 is made of clear plastic in this preferred embodiment and is located about two-thirds of the way to the top and on one side of the zipper flap 20.

Other embodiments of the invention may utilize Velcro strips around the perimeter of the rear of the device to attach it to a door frame instead of the kelder welt and track mounted to the doorframe.

The door and track can be made of several different materials, including plastic. The door will comes in two standard sizes in the preferred embodiment though any size is possible to fit any size opening.

To use the preferred embodiment of EZ2 Seal Door, an individual removes the canvas door from a provided storage bag. Next, he slides the provided track over the kelder welt located on the outer edges of the canvas door. Finally, he mounts the track to the frame of a door with screws or adhesive.

The materials utilized for EZ2 Seal Door may vary widely but could include metals and plastic along with other materials. The metals would ideally be selected from available steel or alloys of steel and aluminum. The production process related to the use of these metals insures that the metal is non-corrosive, durable and strong. The selected metal should have high impact strength and be capable of accepting and retaining coloring materials for an extended length of time.

The plastic used in the production will ideally be selected for durability and longevity. Thermoplastics are commonly used in the manufacturing of components similar to those used in this invention. Polyethylene, polypropylene, and other similar thermoplastic materials would be among those with the necessary traits. Members of this family are recognized universally as being versatile and of high quality.

The plastic components of EZ2 Seal Door can also be formed with the use of plastic molding techniques, such as injection molding or blow molding. Injection molding requires melted plastic to be forcefully injected into relatively cool molds. As the plastic begins to harden, it takes on the shape of the mold cavity. This technique is ideal for the mass production of products. Alternatively, blow molding, a form of extrusion, could be utilized. Blow molding involves a molten tube being pushed into a mold. Compressed air then forces the molten tube against the cold walls of the mold.

It should be obvious that the components of the present invention can be of various shapes and sizes. It should also be obvious that the components of the invention can be made of different types of metals, plastics or other suitable materials and can be of any color.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. A device for sealing an opening comprising:
(a) a fabric door;
(b) a mechanism for attaching the fabric door to a frame of the opening.

2. The device of claim 1 wherein the fabric door is rectangular.

3. The device of claim 1 wherein the fabric door is made of a canvas material.

4. The device of claim 3 wherein the canvas material is twenty-two ounce weblon.

5. The device of claim 1 further comprising
a kelder welt sewn into the outer edges of the fabric door.

6. The device of claim 5 wherein the mechanism for attaching the fabric door to the frame of the opening utilizes the kelder welt threaded through a track that is mounted to the frame of the opening using screws.

7. The device of claim 5 wherein the mechanism for attaching the fabric door to the frame of the opening utilizes the kelder welt threaded through a track that is mounted to the frame of the opening using an adhesive material.

8. The device of claim 1 wherein the mechanism for attaching the fabric door to the frame of the opening involves a Velcro material attached around the perimeter of the rear of the fabric door for adhering to the frame of the opening.

9. The device of claim 6 wherein the track is made of aluminum.

10. The device of claim 6 wherein the track is made of plastic.

11. The device of claim 1 further comprising
a zipper on a zipper track located in approximately the center of the fabric door.

12. The device of claim 11 wherein the zipper is a dual double pull zipper.

13. The device of claim 11 further comprising
a zipper flap located over the zipper track.

14. The device of claim 13 wherein the zipper flap extends from approximately three-quarters of the way to the top of the fabric door to the bottom of the fabric door.

15. The device of claim 1 further comprising
a window in the fabric door.

16. The device of claim 15 wherein the window is made of clear plastic and is located about two-thirds of the way to the top of the fabric door.

17. The device of claim 15 wherein the window is a square that is eight inches by eight inches.

18. A device for sealing an opening comprising:
(a) a canvas door;
(b) a kelder welt sewn into the outer edges of the canvas door wherein the kelder welt is threaded through a track and the track is attached to a frame of the opening;
(c) a zipper track having a dual double pull zipper located in approximately the center of the canvas door and extending from approximately three-quarters of the way to the top of the canvas door to the bottom of the canvas door;
(d) a zipper flap located over the zipper track; and
(e) a window screen in the canvas door located approximately two-thirds of the way to the top of the canvas door.

19. A method of sealing an opening comprising the steps of:
(a) attaching a kelder welt around the outside edges of a fabric door;
(b) sliding a track over the kelder welt located on the outside edges of the canvas door; and
(c) mounting the track to a frame of the opening.
